(19) United States
(12) Patent Application Publication
(10) Pub. No.: US 2024/0422537 A1
(43) Pub. Date: Dec. 19, 2024

(54) METHOD AND WIRELESS NETWORK FOR MANAGING AERIAL INFORMATION OF UUAA CONTEXT

(71) Applicant: Samsung Electronics Co., Ltd., Suwon-si, Gyeonggi-do (KR)

(72) Inventors: Ashok Kumar NAYAK, Bangalore (IN); Dongyeon KIM, Suwon-si (KR); Jungshin PARK, Suwon-si (KR)

(21) Appl. No.: 18/728,357

(22) PCT Filed: Jan. 11, 2023
(86) PCT No.: PCT/KR2023/000510

§ 371 Date: Jul. 11, 2024

(30) Foreign Application Priority Data
Jan. 13, 2022 (IN) 202241002077
Nov. 28, 2022 (IN) 2022 41002077

(51) Int. Cl. H04W 12/06; H04W 60/06; H04W 84/06

(52) U.S. Cl. CPC H04W 12/06; H04W 60/06; H04W 84/06

(57) ABSTRACT

The disclosure relates to a 5G or 6G communication system for supporting a higher data transmission rate. Embodiments herein provide a method for managing aerial information of an UUAA context in a wireless network (1000) by a network device (600). The method includes storing an UUAA Mobility Management (UUAA-MM) context or UUAA Session Management (UUAA-SM) context when an UAV (100) is authenticated and authorized for an Uncrewed Aerial System (CAS) service in the wireless network. Further, the method includes detecting an event associated with an UAV (100) in the wireless network. Further, the method includes removing the stored UUAA-MM context or UUAA-SM context for the UAS service for the UAV (100) in response to detecting the event. Further, the method includes transmitting a message to an UASNF device (300) to unsubscribe for the UAS service for the UAV or to remove the UUAA-MM context or UUAA-SM context stored at the UASNF device (300) for the CAS service for the UAV.

### TECHNICAL FIELD

The present disclosure generally relates to the field of supporting Uncrewed Aerial Systems (UAS) connectivity, identification, and tracking, and more particularly, to a wireless network and a method for managing UAS Service Supplier (USS) UAV Authorization/Authentication (UUAA) context stored at various network functions (NFs) in the wireless network whenever there is a change in aerial services offered for the Uncrewed Aerial Vehicle (UAV). This application is based on and derives the benefit of Indian Provisional Application 20/224,1002077 filed on 13 Jan. 2022, the contents of which are incorporated herein by reference.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

3^{rd} Generation Partnership Project technical specification (3GPP TS) 23.256 defines architecture enhancements for supporting Uncrewed Aerial Systems (UAS) connectivity, identification, and tracking. Typically, an unmanned aerial vehicle (UAV) is authenticated and authorized by a wireless network before it is provided with aerial services. There are two procedures defined such as, Uncrewed Aerial Vehicle (UAV) Authorization and Authentication (UUAA) Mobility Management (UUAA-MM) and UUAA Session Management (UUAA-SM). Generally, the UUAA-MM is performed during a registration procedure by an Access and Mobility Management Function (AMF) device whereas the UUAA-SM is performed during a Protocol Data Unit (PDU) session establishment (or a Packet Data Network (PDN) connection in case of an EPC) by a Session Management Function (SMF) device/a SMF Packet Network Data Gateway-Controller (SMF+PGW-C). In the successful case of the UUAA-MM, the UUAA-MM context is stored by an UASNF device either locally or at a Unstructured Data Storage Function (UDSF). Similarly, the AMF device also stores the UUAA-MM context. In the successful case of the UUAA-SM, the UUAA-SM context is stored by the UASNF device cither locally or at UDSF. Similarly, the SMF device/SMF+PGW-C also stores the UUAA-SM context.

Currently, the UAVs may be authenticated and authorized by the wireless network as part of UUAA-MM or UUAA-SM as per existing configuration and procedures explained in the 3GPP TS 23.256. These contexts are stored at the UASNF device and the AMF device in the case of UUAA-MM whereas it is stored at the UASNF device and the SMF device/the SMF+PGW-C. After the successful execution of either UUAA-MM or the UUAA-SM, many events may occur for the UE (or the UAV) for which these contexts need to be managed. The UE can be, for example, but not limited to a computer system, a personal computer, a smart phone, a Personal Digital Assistant (PDA), a tablet computer, a laptop computer, an Internet of Things (IoT), an embedded system, an edge device, a vehicle to everything (V2X) device or the like.

The events may include UE initiated deregistration, network initiated deregistration, disabling AerialUESubscriptionInfo, DNN(s) subject to aerial services configuration made it to empty at access & mobility management data, slice failure related to aerial services, UE initiated PDU session/PDN connection release intended for aerial service, network initiated PDU session/PDN connection release intended for aerial service and aerial service indication for DNN is disabled at session management data.

The events trigger for a network function (NF) consumer such as, the AMF device and/or the SMF device/the SMF+PGW-C which invokes the UUAA-MM and the UUAA-SM to take some corrective actions. Without these actions, there may be problems which may lead to unnecessarily storing the contexts at various NFs even though the UEs might not be present in the network anymore or may not be authorized to get the UAS service.

FIG. 1 shows an existing representation of a sequence of events for the UUAA-MM contexts in the wireless network when the AMF device (200) detects the events for the UAV (100). As shown FIG. 1, at step 1, the UAV or the UE (100) has already undergone through successful UUAA-MM procedure. The terms “UAV” and the “UE” are used interchangeably in the patent disclosure. At step 2, the AMF device (200) stores the UUAA-MM context. At step 3, the UASNF device (300) stores the UUAA-MM context locally/at the UDSF. Further, at step 4, the AMF device (200) does not take any actions to update the UUAA-MM contexts in the relevant NFs after detecting the events.

Further, in case of reauthentication, reauthorization and revocation, if the NF consumer details are not updated at the UASNF device (300), it may try to reach these NFs. However, in real, the NFs may not be handling aerial services for those UEs anymore. Consider FIG. 2, which shows an existing representation of a sequence of events for UUAA-SM contexts in the network when the SMF device (500a)/SMF+PGW-C (500b) detects mentioned events for the UAV (100). As shown FIG. 2, at step 1, the UAV or the UE (100) may have been already undergone through successful UUAA-SM procedure. At step 2, the SMF device (500a)/SMF+PGW-C (500b) stores the UUAA-SM context. At step 3, the UASNF device (300) stores the UUAA-SM context locally/UDSF. Further, at step 4, the SMF device (500a)/(SMF+PGW-C (500b) does not take any actions to update the UUAA-SM contexts in the relevant NFs after detecting the events.

Thus, it is desired to address the above mentioned disadvantages or other shortcomings or at least provide a useful alternative.

### Solution to Problem

Accordingly, the embodiment herein discloses a method for managing aerial information of an Uncrewed Aerial Vehicle (UAV) Authorization and Authentication (UUAA) context in a wireless network. The method includes storing, by a network device in the wireless network, an UUAA Mobility Management (UUAA-MM) context or UUAA Session Management (UUAA-SM) context when an UAV (or UE) is authenticated and authorized for an Uncrewed Aerial System (UAS) service in the wireless network. Further, the method includes detecting, by the network device, at least one event associated with an UAV in the wireless network. Further, the method includes removing, by the network device, the stored UUAA-MM context or UUAA-SM context for the UAS service for the UAV in response to detecting the at least one event. Further, the method includes transmitting, by the network device, a message to an UASNF device to unsubscribe for the UAS service for the UAV or to remove the UUAA-MM context or UUAA-SM context stored at the UASNF device for the UAS service for the UAV.

In an embodiment, the network device is one of an Access and Mobility Management Function (AMF) device, a Session Management Function (SMF) device, and a SMF Packet Network Data Gateway-Controller (SMF-PGW-C).

In an embodiment, the at least one event detected at the AMF device comprises at least one of the UAV initiated deregistration for the UAS service, a network-initiated deregistration for the UAV, an Aerial UE Subscription Information for the UAS service for the UAV is disabled, a DNN subject to an UAS service configuration made it to empty at access and mobility management data and slice failure related to the UAS service for the UAV.

In an embodiment, the at least one event detected at the SMF device or the SMFPGW-C comprises at least one of the UAV initiated a Protocol Data Unit (PDU) session or a Packet Data Network (PDN) connection release intended for the UAS service for the UAV, a network initiated a PDU session or a PDN connection release intended for the UAS service for the UAV, identification of a last PDU session intended for the UAS service for the UAV, and an UAS service indication for a DNN is disabled at session management data.

In an embodiment, the method includes sending, by the network device, a message to clear the UUAA-MM context or UUAA-SM context to a UE (or the UAV). In an example, when the SMF device release the PDU session one existing message “PDU is released” is sent towards the UE. Either, this existing message can carry that additional information to remove the context or a new message can be used by SMF device towards the UAV (or the UE) from the SMF device.

Accordingly, the embodiment herein discloses a method for managing aerial information of an UUAA context in a wireless network. The method includes storing, by an UASNF device in the wireless network, an UUAA Mobility Management (UUAA-MM) context or UUAA Session Management (UUAA-SM) context when an UAV is authenticated and authorized for an Uncrewed Aerial System (UAS) service in the wireless network. Further, the method includes receiving, by the UASNF device, a message from a network device in the wireless network to unsubscribe for the UAS service for the UAV or to remove the UUAA-MM context or UUAA-SM context stored at the UASNF device for the UAS service, when at least one event associated with the UAV is detected at the network device. Further, the method includes removing, by the UASNF device, the stored UUAA-MM context or UUAA-SM context for the UAS service for the UAV based on the received message. Further, the method includes transmitting, by the UASNF device, a message to a UAS Service Supplier (USS) device for the removal of the UAS service for the UAV.

In an embodiment, the method includes receiving, by a User Equipment (UE), a message to clear the UUAA-MM context or UUAA-SM context from the network device. Further, the method includes clearing, by the UE, the UUAA-MM context or UUAA-SM context after receiving the message from the network device.

Accordingly, the embodiment herein discloses a network device for managing aerial information of an Uncrewed Aerial Vehicle (UAV) Authorization and Authentication (UUAA) context in a wireless network. The network device includes a UUAA context management controller communicatively coupled to a memory and a processor. The UUAA context management controller is configured to store an UUAA-MM context or UUAA-SM context when an UAV is authenticated and authorized for an UAS service in the wireless network. Further, the UUAA context management controller is configured to detect at least one event associated with an UAV in the wireless network. Further, the UUAA context management controller is configured to remove the stored UUAA-MM context or UUAA-SM context for the UAS service for the UAV in response to detecting the at least one event. Further, the UUAA context management controller is configured to transmit a message to an UASNF device to unsubscribe for the UAS service for the UAV or to remove the UUAA-MM context or UUAA-SM context stored at the UASNF device for the UAS service for the UAV.

Accordingly, the embodiment herein discloses an UASNF device for managing aerial information of an UUAA context in a wireless network. The UASNF device includes an UUAA context management controller communicatively coupled to a memory and a processor. The UUAA context management controller stores an UUAA Mobility Management (UUAA-MM) context or UUAA Session Management (UUAA-SM) context when an UAV is authenticated and authorized for an Uncrewed Aerial System (UAS) service in the wireless network. Further, the UUAA context management controller receives a message from a network device in the wireless network to unsubscribe for the UAS service for the UAV or to remove the UUAA-MM context or UUAA-SM context stored at the UASNF device for the UAS service, when at least one event associated with the UAV is detected at the network device. Further, the UUAA context management controller removes the stored UUAA-MM context or UUAA-SM context for the UAS service for the UAV based on the received message. Further, the UUAA context management controller transmits a message to a UAS Service Supplier (USS) device for the removal of the UAS service for the UAV.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

The principal object of the embodiments herein is to provide a method and a wireless network for managing aerial information of an UUAA context in the wireless network. The method can be used for managing UUAA contexts stored at various NFs such as UASNF device, AMF device or SMF device/SMF+PGW-C during multiple events occurs for the UAV at the wireless network.

### BRIEF DESCRIPTION OF DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1 shows an existing representation of a sequence of events for UUAA-MM contexts in a wireless network when an AMF device detects mentioned events for an UAV (or UE);

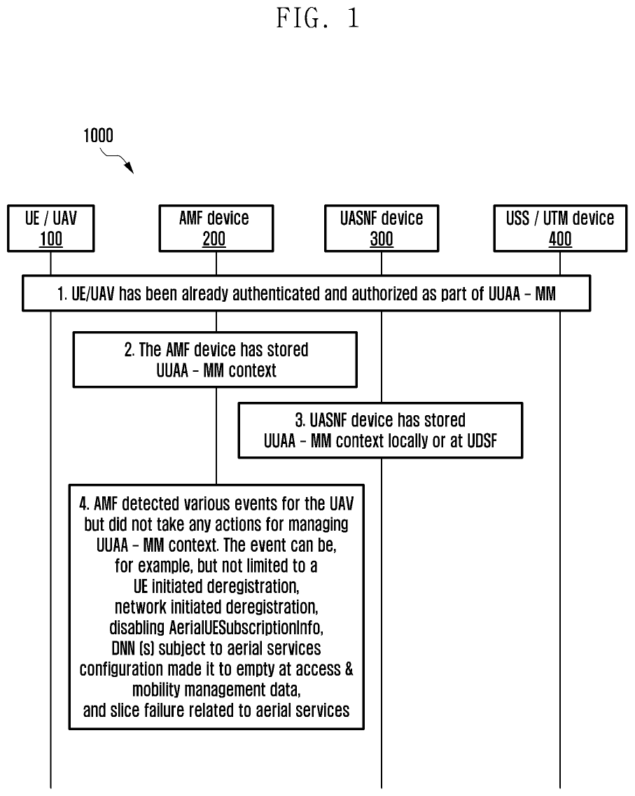

FIG. 2 shows an existing representation of a sequence of events for UUAA-SM contexts in the wireless network when a SMF device/a SMF+PGW-C detects mentioned events for the UAV;

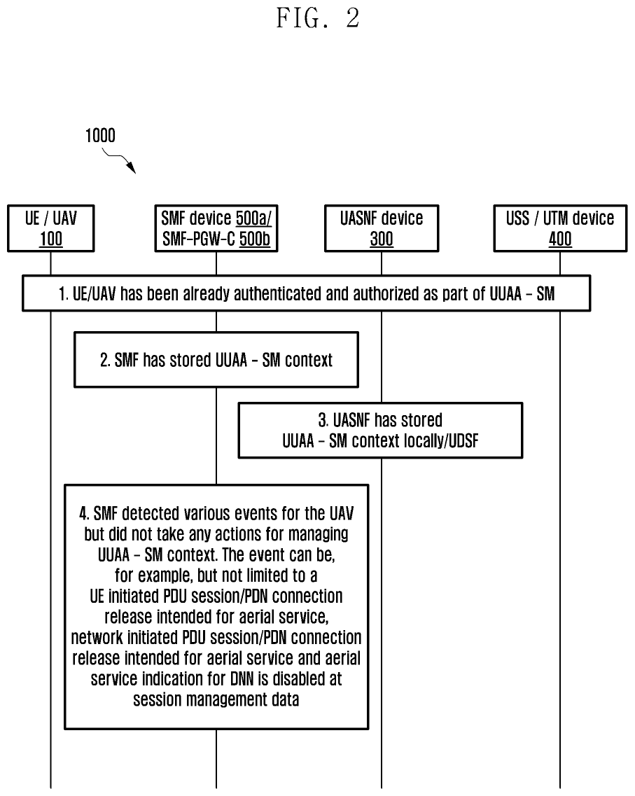

FIG. 3 shows an exemplary representation of a sequence of events for managing UUAA-MM contexts in the wireless network, in accordance with some embodiments of the present disclosure;

FIG. 4, shows an exemplary of a sequence of events for managing UUAA-SM contexts in the wireless network, in accordance with some embodiments of the present disclosure;

FIG. 5 shows various hardware components of a network device, according to the embodiments as disclosed herein;

FIG. 6 shows various hardware components of a UASNF device, according to the embodiments as disclosed herein;

FIG. 7 is a flow chart illustrating a method, implemented by the network device, for managing aerial information of an Uncrewed Aerial Vehicle (UAV) Authorization and Authentication (UUAA) context in the wireless network, according to the embodiments as disclosed herein; and

FIG. 8 is a flow chart illustrating a method, implemented by the UASNF device, for managing aerial information of an UUAA context in the wireless network, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for managing aerial information of an UUAA context in a wireless network. The method includes storing, by a network device in the wireless network, an UUAA-MM context or UUAA-SM context when an UAV (or UE) is authenticated and authorized for an Uncrewed Aerial System (UAS) service in the wireless network. Further, the method includes detecting, by the network device, at least one event associated with an UAV in the wireless network. Further, the method includes removing, by the network device, the stored UUAA-MM context or UUAA-SM context for the UAS service for the UAV in response to detecting the at least one event. Further, the method includes transmitting, by the network device, a message to an UASNF device to unsubscribe for the UAS service for the UAV or to remove the UUAA-MM context or UUAA-SM context stored at the UASNF device for the UAS service for the UAV.

The present disclosure provides a method and a wireless network for managing UUAA contexts stored at various NFs such as, UASNF device, AMF device or SMF device/SMF+PGW-C during multiple events occurs for the UE at network. The present disclosure discloses actions for NF consumers like AMF device and/or SMF device/SMF+PGW-C.

When the list of events occurred in the network then only AMF, SMF/SMF+PGW-C knows about it because it handles the events. But the UAS service is mainly triggered and handled by USS which does the UAV authentication and authorization and provide specific policy to provide aerial service. If the USS does not know that these events occurred then it can continue to trigger re-authentication which in the end will fail. Similarly, the UAS NF which does all the UAV operation towards the USS maintains the context to manage it. If it is unaware of these events then it will continue to hold stale contexts and send messages towards the AMF/SMF.

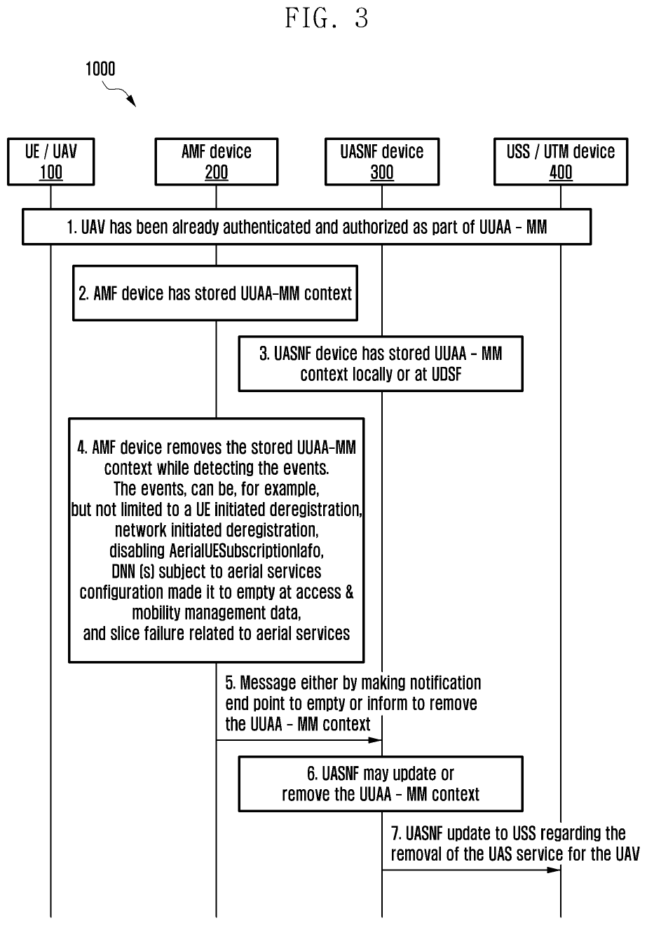

Referring now to the drawings and more particularly to FIGS. 3 through 8, where similar reference characters denote corresponding features consistently throughout the figures, there are shown preferred embodiments.

FIG. 3 shows an exemplary representation of a sequence of events for managing UUAA Mobility Management (UUAA-MM) contexts in the wireless network (1000), in accordance with some embodiments of the present disclosure. As shown in FIG. 3, consider a case when the events such as, UE initiated deregistration, network-initiated deregistration, AerialUESubscriptionInfo is disabled, DNN(s) subject to aerial services configuration made it to empty at access and mobility management data and slice failure related to aerial services, and the like occur. In such case, the AMF device (200) may remove the stored UUAA-MM context. Also, either AMF device (200) may unsubscribe by sending a message to the UASNF device (300) with notification end point to empty or simply inform the UASNF device (300) to remove the UUAA-MM context which UASNF device (300) has stored at locally/UDSF. Further, the AMF device (200) may indicate the SMF device (500a) to release all PDU sessions relevant for aerial services. Further, the UASNF device (300) may update or remove the UUAA-MM context and update to UAS Service Supplier (USS) device (or UTM device) (400) such that the USS device (400) may not trigger re-authentication, reauthorization and revocation. Thus, the UEs may be notified to clear the context.

As shown FIG. 3, at step 1, the UAV or the UE (100) has been already authenticated and authorized as part of UUAA-MM. At step 2, the AMF device (200) stores the UUAA-MM context. At step 3, the UASNF device (300) stores the UUAA-MM context locally/at the UDSF. Further, at step 4, the AMF device (200) removes the stored UUAA-MM context while detecting the events. At 5, the AMF device (200) sends the message to the UASNF device (300), where the message is used either by making notification end point to empty or inform to remove the UUAA-MM context. At 6, the UASNF device (300) may update or remove the UUAA-MM context based on the message. At 7, the UASNF device (300) updates to the USS device/UTM device (400) regarding the removal of the UAS service for the UAV.

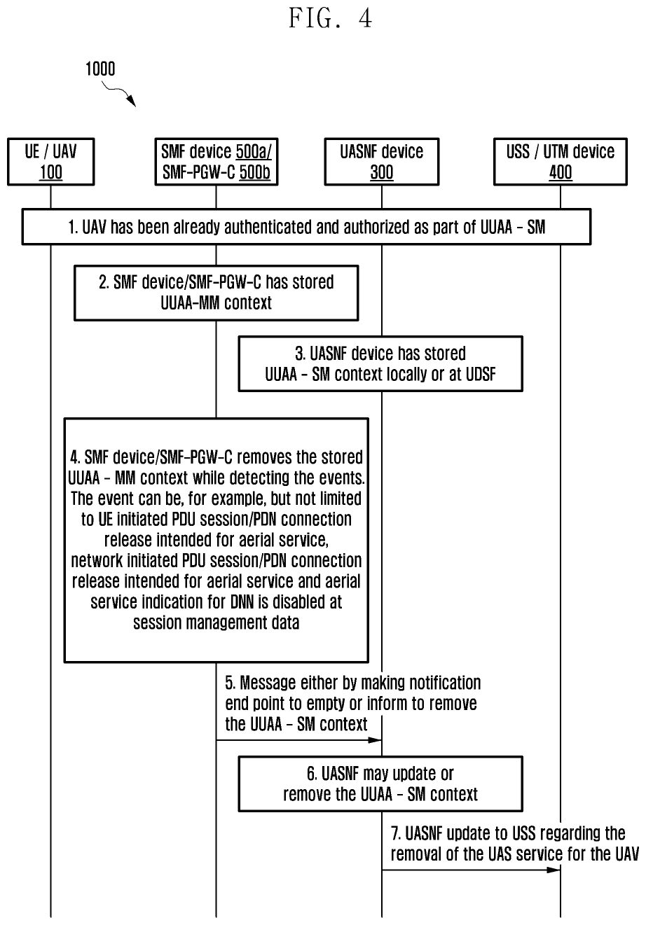

FIG. 4 shows an exemplary of a sequence of events for managing UUAA Session Management (UUAA-SM) contexts in the wireless network (1000), in accordance with some embodiments of the present disclosure.

As shown in FIG. 4, consider a case when the events such as, UE initiated PDU session/PDN connection release intended for aerial service and network initiated PDU session/PDN connection release intended for aerial service, and the like occur. Further, if the SMF device (500a)/SMF+PGW-C (500b) identifies that this is the last PDU session intended for the aerial service or aerial service indication for the DNN is disabled at session management data. In such case, the SMF device (500a)/SMF+PGW-C (500b) may remove the stored UUAA-SM context. Also, in such case, either the SMF device (500a)/SMF+PGW-C (500b) may unsubscribe by sending message to the UASNF device (300) with notification end point to empty or simply inform the UASNF device (300) to remove the UUAA-SM context which UASNF device (300) has stored at locally/UDSF. Further, the UASNF device (300) may remove or update the UUAA-SM context and update to the USS device (400) such that the USS device (400) may not trigger re-authentication, reauthorization and revocation. The UEs may be notified to clear the context as well.

As shown FIG. 4, at step 1, the UAV or the UE (100) has been already authenticated and authorized as part of UUAA-SM. At step 2, the SMF device (500a) or the SMFPGW-C (500b) stores the UUAA-MM context. At step 3, the UASNF device (300) stores the UUAA-SM context locally/at the UDSF. Further, at step 4, the SMF device (500a) or the SMF-PGW-C (500b) removes the stored UUAA-MM context while detecting the events. At 5, SMF device (500a) or the SMF-PGW-C (500b) sends the message to the UASNF device (300), where the message is used either by making notification end point to empty or inform to remove the UUAA-SM context. At 6, the UASNF device (300) may update or remove the UUAA-SM context based on the message. At 7, the UASNF device (300) updates to the USS device/UTM device (400) regarding the removal of the UAS service for the UAV.

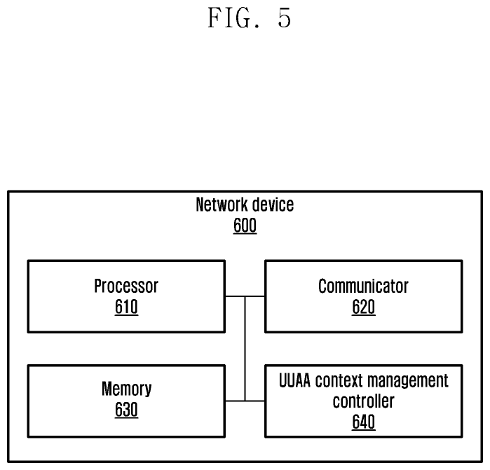

FIG. 5 shows various hardware components of a network device (600), according to the embodiments as disclosed herein. The network device (600) can be, for example, but not limited to the AMF device (200), the SMF device (500a), and the SMF-PGW-C (500b). In an embodiment, the network device (600) includes a processor (610), a communicator (620), a memory (630) and an UUAA context management controller (640). The processor (610) is coupled with the communicator (620), the memory (630) and the UUAA context management controller (640).

The UUAA context management controller (640) stores the UUAA-MM context or the UUAA-SM context when the UAV (100) is authenticated and authorized for the UAS service in the wireless network (1000). The wireless network (1000) can be, for example, but not limited to, a fourth generation (4G) network, a fifth generation (5G) network, a sixth generation (6G) network, an open radio access network (ORAN) network or the like. Further, the UUAA context management controller (640) detects the event associated with an UAV (100) in the wireless network (1000). In an embodiment, the event detected at the AMF device (200) includes at least one of the UAV (100) initiated deregistration for the UAS service, the network-initiated deregistration for the UAV (100), the Aerial UE Subscription Information for the UAS service for the UAV (100) is disabled, the DNN subject to the UAS service configuration made it to empty at access and mobility management data and slice failure related to the UAS service for the UAV (100).

In another embodiment, the event detected at the SMF device (500a) or the SMFPGW-C (500b) comprises at least one of the UAV (100) initiated the PDU session or a Packet Data Network (PDN) connection release intended for the UAS service for the UAV (100), a network initiated a PDU session or a PDN connection release intended for the UAS service for the UAV (100), identification of a last PDU session intended for the UAS service for the UAV (100), and the UAS service indication for the DNN is disabled at session management data.

Upon detecting the event, the UUAA context management controller (640) removes the stored UUAA-MM context or UUAA-SM context for the UAS service for the UAV (100). Further, the UUAA context management controller (640) transmits the message to the UASNF device (300) to unsubscribe for the UAS service for the UAV (100) or to remove the UUAA-MM context or UUAA-SM context stored at the UASNF device (300) for the UAS service for the UAV (100). Further, the UUAA context management controller (640) sends the message to clear the UUAA-MM context or UUAA-SM context to the UE. In an example, when the SMF device (500a) releases the PDU one existing message “PDU is released” is there towards the UE (or the UAV (100)). Either this existing message can carry that additional info to remove the context or a new message can be used by the SMF device (500a) towards the UE from the SMF device (500a).

The UUAA context management controller (640) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (610) is configured to execute instructions stored in the memory (630) and to perform various processes. The communicator (620) is configured for communicating internally between internal hardware components and with external devices via one or more networks. The memory (630) also stores instructions to be executed by the processor (610). The memory (630) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

Although the FIG. 5 shows various hardware components of the network device (600) but it is to be understood that other embodiments are not limited thereon. In other embodiments, the network device (600) may include less or more number of components. Further, the labels or names of the components are used only for illustrative purpose and does not limit the scope of the invention. One or more components can be combined together to perform same or substantially similar function in the network device (600).

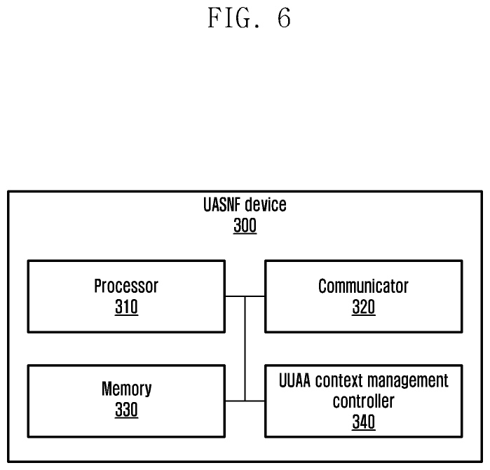

FIG. 6 shows various hardware components of the UASNF device (300), according to the embodiments as disclosed herein. In an embodiment, the UASNF device (300) includes a processor (310), a communicator (320), a memory (330) and an UUAA context management controller (340). The processor (310) is coupled with the communicator (320), the memory (330) and the UUAA context management controller (340).

The UUAA context management controller (340) stores the UUAA-MM context or the UUAA-SM context when the UAV (100) is authenticated and authorized for the UAS service in the wireless network (1000). Further, the UUAA context management controller (340) receives the message from the network device (600) in the wireless network (1000) to unsubscribe for the UAS service for the UAV (100) or to remove the UUAA-MM context or UUAA-SM context stored at the UASNF device (300) for the UAS service, when event associated with the UAV (100) is detected at the network device (600). Further, the UUAA context management controller (340) removes the stored UUAA-MM context or UUAA-SM context for the UAS service for the UAV (100) based on the received message. Further, the UUAA context management controller (340) transmits the message to the USS device (or UTM device) (400) for the removal of the UAS service for the UAV (100).

The UUAA context management controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 6 shows various hardware components of the UASNF device (300) but it is to be understood that other embodiments are not limited thereon. In other embodiments, the UASNF device (300) may include less or more number of components. Further, the labels or names of the components are used only for illustrative purpose and does not limit the scope of the invention. One or more components can be combined together to perform same or substantially similar function in the UASNF device (300).

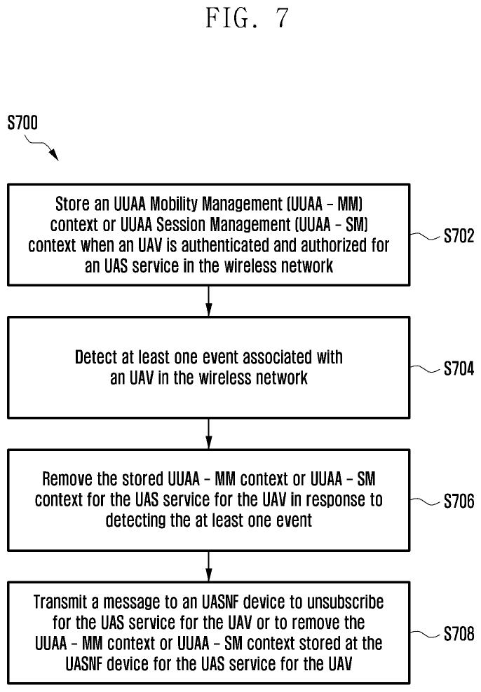

FIG. 7 is a flow chart (S700) illustrating a method, implemented by the network device (600), for managing aerial information of the UUAA context in the wireless network (1000), according to the embodiments as disclosed herein. The operations (S702-S708) are handled by the UUAA context management controller (640).

At S702, the method includes storing the UUAA-MM context or the UUAA UUAA-SM context when the UAV (100) is authenticated and authorized for the UAS service in the wireless network (1000). At S704, the method includes detecting the event associated with the UAV (100) in the wireless network (1000). At S706, the method includes removing the stored UUAA-MM context or UUAA-SM context for the UAS service for the UAV (100) in response to detecting the event. At S708, the method includes transmitting the message to the UASNF device (300) to unsubscribe for the UAS service for the UAV (100) or to remove the UUAA-MM context or UUAA-SM context stored at the UASNF device (300) for the UAS service for the UAV (100).

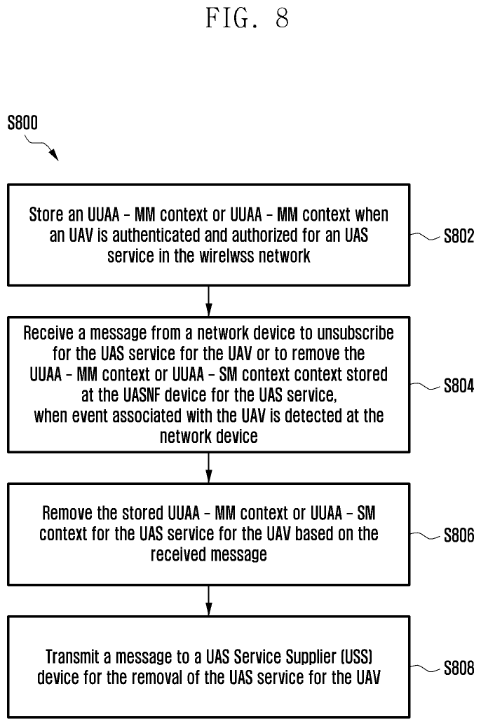

FIG. 8 is a flow chart (S800) illustrating a method, implemented by the UASNF device (300), for managing aerial information of the UUAA context in the wireless network (1000), according to the embodiments as disclosed herein. The operations (S802-S808) are handled by the UUAA context management controller (340)

At S802, the method includes storing the UUAA-MM context or the UUAA-SM context when the UAV (100) is authenticated and authorized for the UAS service in the wireless network (1000). At S804, the method includes receiving the message from the network device (600) to unsubscribe for the UAS service for the UAV (100) or to remove the UUAA-MM context or the UUAA-SM context stored at the UASNF device (300) for the UAS service, when the event associated with the UAV (100) is detected at the network device (600). At S806, the method includes removing the stored UUAA-MM context or UUAA-SM context for the UAS service for the UAV (100) based on the received message. At S808, the method includes transmitting the message to the USS device (400) for the removal of the UAS service for the UAV (100).

The various actions, acts, blocks, steps, or the like in the flow charts (S700 and S800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1.-15. (canceled)

16. A method performed by a network device in a wireless communication system, the method comprising:
performing an uncrewed aerial system (UAS) uncrewed aerial vehicle (UAV) authorization and authentication (UUAA) mobility management (UUAA-MM) or an UUAA session management (UUAA-SM);
detecting at least one event associated with a UAV; and
transmitting, to a UAS network function (UASNF), a message to unsubscribe for the UAV,
wherein a UUAA-MM context or a UUAA-SM context is cleared and a UAS service supplier (USS) is updated.

17. The method as claimed in claim 16, wherein the at least one event is associated with a user equipment (UE) deregistration and the UUAA-MM context is cleared in case that the network device is an access and mobility management function (AMF) device.

18. The method as claimed in claim 16, wherein the at least one event is associated with a protocol data unit (PDU) session release and the UUAA-SM context is cleared in case that the network device is a session management function (SMF) device.

19. The method as claimed in claim 16, further comprising:
removing the UUAA-MM context or the UUAA-SM context for the UAV in response to detecting the at least one event.

20. A method performed by an uncrewed aerial system (UAS) network function (UASNF) in a wireless communication system, the method comprising:
performing a UAS uncrewed aerial vehicle (UAV) authorization and authentication (UUAA) mobility management (UUAA-MM) or an UUAA session management (UUAA-SM);
receiving, from a network device, a message to unsubscribe for a UAV, when at least one event associated with the UAV is detected at the network device;
clearing a UUAA-MM context or a UUAA-SM context; and
updating a UAS service supplier (USS).

21. The method as claimed in claim 20, wherein the at least one event is associated with a user equipment (UE) deregistration and the UUAA-MM context is cleared in case that the network device is an access and mobility management function (AMF) device.

22. The method as claimed in claim 20, wherein the at least one event is associated with a protocol data unit (PDU) session release and the UUAA-SM context is cleared in case that the network device is a session management function (SMF) device.

23. The method as claimed in claim 20, further comprising:
transmitting, to the USS, a message for updating.

24. A network device in a wireless communication system, the network device comprises:
a memory;
a processor; and
an uncrewed aerial system (UAS) uncrewed aerial vehicle (UAV) authorization and authentication (UUAA) context management controller, communicatively coupled to the memory and the processor, configured to:
perform a UUAA mobility management (UUAA-MM) or an UUAA session management (UUAA-SM),
detect at least one event associated with a UAV, and
transmit, to a UAS network function (UASNF), a message to unsubscribe for the UAV,
wherein a UUAA-MM context or a UUAA-SM context is cleared and a UAS service supplier (USS) is updated.

25. The network device as claimed in claim 24, wherein the at least one event is associated with a user equipment (UE) deregistration and the UUAA-MM context is cleared in case that the network device is an access and mobility management function (AMF) device.

26. The network device as claimed in claim 24, wherein the at least one event is associated with a protocol data unit (PDU) session release and the UUAA-SM context is cleared in case that the network device is a session management function (SMF) device.

27. The network device as claimed in claim 24, wherein the UUAA context management controller is further configured to:
remove the UUAA-MM context or the UUAA-SM context for the UAV in response to detecting the at least one event.

28. An uncrewed aerial system (UAS) network function (UASNF) in a wireless communication system, the UASNF comprises:
a memory;
a processor; and
a UAS uncrewed aerial vehicle (UAV) authorization and authentication (UUAA) context management controller, communicatively coupled to the memory and the processor, configured to:
perform a UUAA mobility management (UUAA-MM) or an UUAA session management (UUAA-SM),
receive, from a network device, a message to unsubscribe for a UAV, when at least one event associated with the UAV is detected at the network device,
clear a UUAA-MM context or a UUAA-SM context, and
update an UAS service supplier (USS).

29. The UASNF as claimed in claim 28, wherein the at least one event is associated with a user equipment (UE) deregistration and the UUAA-MM context is cleared in case that the network device is an access and mobility management function (AMF) device.

30. The UASNF as claimed in claim 28, wherein the at least one event is associated with a protocol data unit (PDU) session release and the UUAA-SM context is cleared in case that the network device is a session management function (SMF) device.
